(19) United States
(12) Patent Application Publication
(10) Pub. No.: US 2013/0179621 A1
(43) Pub. Date: Jul. 11, 2013

(54) EXTENSIBLE DAISY-CHAIN TOPOLOGY FOR COMPUTE DEVICES

(71) Applicants: Glenn Willis Smith, Ruckersville, VA (US); Peter Missel, Augsburg (DE); Harald Gruber, Augsburg (DE)

(72) Inventors: Glenn Willis Smith, Ruckersville, VA (US); Peter Missel, Augsburg (DE); Harald Gruber, Augsburg (DE)

(21) Appl. No.: 13/345,592

(22) Filed: Jan. 6, 2012

(51) Int. Cl. G06F 13/20

(52) U.S. Cl. 710/313

(57) ABSTRACT

Devices, systems and methods for providing a daisy-chain topology for networking compute devices having PCIe bridges are disclosed. The daisy-chain topology is an extensible PCIe or similar standard solution that allows for a variable number of nodes. The topology has no chassis and no fixed slots, and there is no single device or bridge designated as the PCIe root. This topology allows additional devices to be added to the daisy-chain without construction of a new chassis. Some or all of can be mechanically coupled to provide a common communication channel. Once connected on the expansion link, any device has the ability to communicate to any other device on the daisy-chain. The devices on the daisy-chain are able to let their CPU or processors directly talk to those of another device. This results in a master/master relationship rather than one device serving as the master and the remaining devices the slaves.

### BACKGROUND OF THE INVENTION

1. Field of the Invention

The field of the invention relates to control systems generally, and more particularly to certain new and useful advances in network topologies connecting multiple devices within control systems for industrial applications, of which the following is a specification.

2. Description of Related Art

At a high level, controller devices are essentially specialized computers that contain most of the components found in a personal computer (hereinafter PC) today-including central processing units (hereinafter CPUs), memory, disk drives, and various input and output (hereinafter I/O) connections. Like computers, controller devices can be linked together in a network in order to communicate information and transfer data back and forth quickly and efficiently.

PCI™ (hereinafter PCI) and its successor PCI Express® (hereinafter PCIe) are serial bus standards that provide electrical, physical and logical interconnections for peripheral components of microprocessor-based systems. The native topology of connections supported by PCIe emulates the tree structure of its predecessor PCI. The native PCI tree topology allows only one master CPU in the system. This master CPU is known as a root complex. Other CPUs and similar compute devices can be connected to the PCI tree as a leaf node to the root complex. If the primary root complex fails, the CPU connected through the non-transparent (hereinafter NT) bridge can take over system control and become the new root complex.

Tree structures have some drawbacks for the needs of modern control systems that connect multiple controller devices in a network. For example, in the standard PCIe tree, all devices must be initialized by a common root complex in a process referred to as PCIe enumeration. The root complex must be aware of all PCIe devices in the network in order for the enumeration process and future communication to be successful. This limits the topology of devices to tree or star topologies and prevents the use of daisy-chained or ring topologies.

Thus, there is a need for devices, systems and methods that take advantage of the high-speed connection capabilities of the PCIe standard without the drawbacks and constraints of known network configurations for PCIe devices.

### BRIEF SUMMARY OF THE INVENTION

The devices, systems and methods of the subject invention are directed to connecting multiple devices in a daisy-chain topology. The daisy-chain or expansion topology of the subject invention is an extensible solution that allows for a variable number of nodes. Conventional PCIe devices are connected to a chassis with a fixed number of slots. In addition, PCIe devices are typically connected in a tree or star-topology with a single PCIe device serving as the PCIe root. In contrast, the devices, systems and methods of the subject invention do not require a chassis and do not require any fixed slots. In the subject invention, there is no single device or bridge designated as the PCIe root. Rather, the subject invention allows additional devices to be added to the daisy-chain topology without construction of a new chassis.

PCIe devices can be connected either through a cable or through direct module-to-module connectors. This allows flexibility in the connection of the devices which could also be simply stacked to provide a communication channel. In addition, if devices in the subject invention need to be some distance apart, then a connector, such as a PCIe cable can provide the connection as well. Alternately, the subject invention provides a hybrid connection that may be used to connect some groups of modules by physically stacking the modules or devices, and then linking the separate stacks with a connector, such as a PCIe cable. Once a device is connected on the daisy-chain topology, any device has the ability to communicate to any other device present on the network. The devices are thereby able to let their CPU or processors directly talk to each of the CPU and processors of other devices in the network. The subject invention therefore enables a master/master or peer-to-peer relationship between devices on the daisy-chain rather than any one device serving as the master and the remaining devices the slaves.

One embodiment of the present invention is a system comprising a first set of devices, each of the first set of devices having a central processing unit connected to an internal PCIe bridge, wherein each of the first set of devices are connected to each other in a peer-to-peer arrangement along an external PCIe bus in a daisy-chain topology. The PCIe bridge of each of the plurality of devices may have at least one NT port. The system of the PCIe bridge of each of the plurality of devices may have a first and a second port for connecting its respective device to the external bus, and may further comprise a third port for transmitting and receiving data to and from the respective device to one or more of the first set of devices in the daisy-chain topology. In another embodiment, the system of the present invention further comprises a second set of devices, each of the second set of devices having a central processing unit connected to a PCIe bridge. The second set of devices may be mechanically coupled or mated together. The at least one of the second set of devices may be connected along the external bus to the daisy-chain topology. In a further embodiment, the second set of devices can communicate or transfer data back and/or forth along a common communication channel when mechanically coupled.

A method of providing data transfer between an initiating device and a target device is also provided. In one embodiment, the method comprises the steps of providing a plurality of devices including an initiating device and a target device, each of the plurality of devices having a NT PCIe bridge; connecting the plurality of devices in a peer-to-peer daisy-chain topology; and performing transfer of data by traversing the daisy-chain topology starting from the initiating device and ending at the target device. The method may include a PCIe bridge that comprises at least a first port, a second port, and a third port. In another embodiment, the method comprises the step of connecting the plurality of devices in the daisy-chain topology, which includes cabling the first and second ports of each of the devices to an external expansion bus. The external expansion bus may be a PCIe connector. In yet another embodiment, the method further comprises the step of connecting the third port to an internal PCIe bus within each of the plurality of devices, respectively. In a further embodiment, the method further comprises the step of selecting one of the first port and the second port on the initiating device from which to begin transfer of the data based on a direction of the target device on the external expansion bus. The method may further comprise the step of reading or writing the data within an internal memory of the target device, after the daisy-chain topology has been traversed and transfer of data to and/or from the target device is completed.

The devices, systems and methods of the subject invention provide a networking solution for compute devices that eliminates the need for users to buy a chassis or external bridge switch to interconnect modules or devices, potentially saving space in an industrial setting, for example. The ability to add PCIe devices in differing topologies, other than the native PCIe tree, gives a user the flexibility to configure and implement a network in a unique way for whatever their needs may be. Furthermore, allowing multiple CPUs to work together increases performance and provides redundant more robust systems.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1A is a diagram illustrating multiple compute devices connected in a daisy-chain according to the subject invention;

FIG. 1B is a diagram illustrating multiple devices connected in a daisy chain topology according to the present invention, along with one exemplary stack of three devices being mechanically connected to each other and electrically connected to the other devices in the daisy-chain topology;

FIG. 2 is a diagram of an exemplary compute device according to the present invention, the device including a CPU connected to a PCIe bridge; the PCIe bridge having at least one NT port; and left and right physical connections connecting the compute device to the daisy-chain;

FIG. 3 is a block diagram illustrating the flow of data transfer from an initiating device to a target device starting at the non-transparent port of the initiating device, traversing the daisy-chain, and terminating at the local random access memory (hereinafter RAM) of the CPU of the target device (not shown);

FIG. 4 is a block diagram illustrating the address translation between compute devices connected in a daisy-chain topology according to the present invention;

FIG. 5 is a diagram showing the memory address translations between the respective PCIe bridges of compute devices connected in the daisy-chain topology of the present invention;

FIG. 6A is a table showing an example of the NT bridge memory windows seen by a given compute device's CPU in an exemplary system of the subject invention, in which there are five compute devices connected in a daisy-chain; and

FIG. 6B is a table showing an example of memory translations for one compute device in the exemplary system of FIG. 6A.

Like reference characters designate identical or corresponding components throughout the several views, which are not to scale unless otherwise indicated.

### DETAILED DESCRIPTION OF THE INVENTION

The devices, systems and methods of the subject invention are directed to an extensible topology for connecting compute devices. The subject invention is particularly useful for applications where high bandwidth, low latency, redundancy and ease of expansion are desired. The subject invention enables compute devices to be networked in an extensible daisy-chain or linear topology. In one embodiment, a bridge, such as a PCIe bridge or switch, is integrated into every node of the expansion. This PCIe bridge supports NT bridging and Spread-Spectrum Clocking The subject invention overcomes the native topology of communication bus standards, like PCIe, in order to achieve a number of benefits and advantages over known devices, systems and methods as described herein.

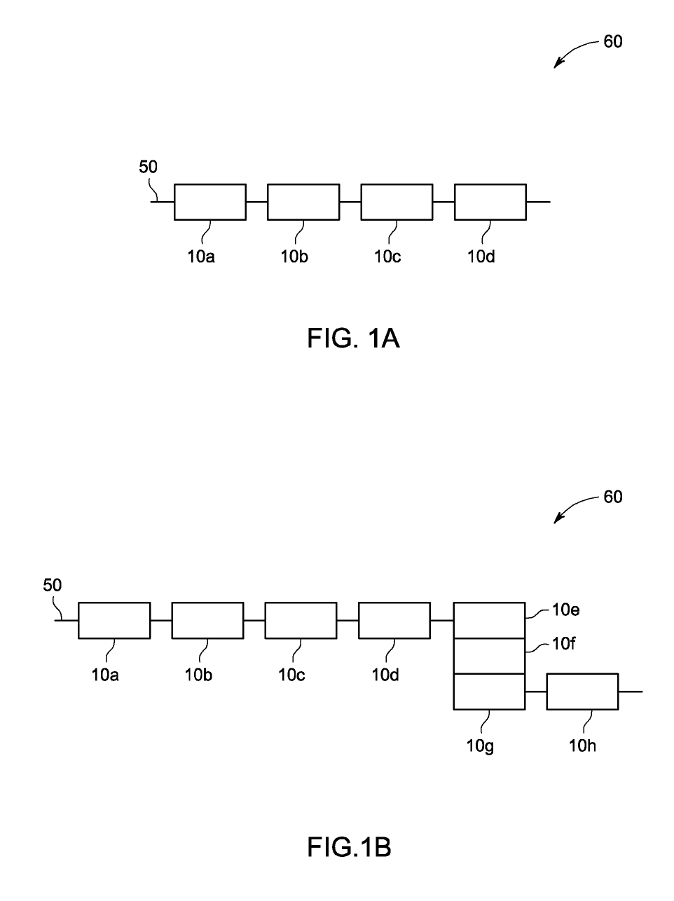

FIG. 1A is an exemplary block diagram of a system 60 according to the present invention having multiple compute devices connected in a daisy-chain topology. Two or more networked compute devices may be used to achieve the benefits of the subject invention. In the exemplary embodiment of FIG. 1, there are four compute devices 10a, 10b, 10c and 10d connected along an external expansion bus 50. Each of the devices 10a-10d has an internal PCIe port for connecting an internal PCIe bus of each of the devices to the daisy-chain. This allows access to the local compute device's RAM for memory transactions and allows the local CPU present within each device to initiate transactions. Each compute device 10a-10d can communicate in a peer-to-peer relationship, or multi-master mode, with every other device connected to the expansion bus 50. No compute device 10a-10d on the daisy-chain is a slave to any other device.

FIG. 1B is an exemplary block diagram of devices connected in a daisy chain topology according to the present invention, with one exemplary stack of multiple devices being connected in the daisy-chain topology. In this embodiment, there are eight devices 10a, 10b, 10c, 10d, 10e 10f, 10g, and 10h. Like FIG. 1A, devices 10a-10d are daisy-chained and connected to an expansion bus 50 via a physical connection, such as a PCIe cable, to the network. Devices 10e-10g are mechanically coupled and electrically connected in a stack. Two or more devices or modules may be physically stacking and/or mechanically coupled, and then linked with a stacking connector, such as a PCIe cable, so that each device in the stack is able to communicate and transfer data within the stack and within the daisy chain. Because of the extensible nature of the topology of the subject invention, additional individual devices, such as device 10h, can be daisy-chained to the end of one or more stacks of devices, such as devices 10e-10g in FIG. 1B. Multiple stacks of devices may also be daisy chained together. Although the devices 10e-10g are present in the network in a mechanically coupled stack, they may still be adapted and configured to communicate with the other devices in the network in a peer-to-peer or master/master arrangement.

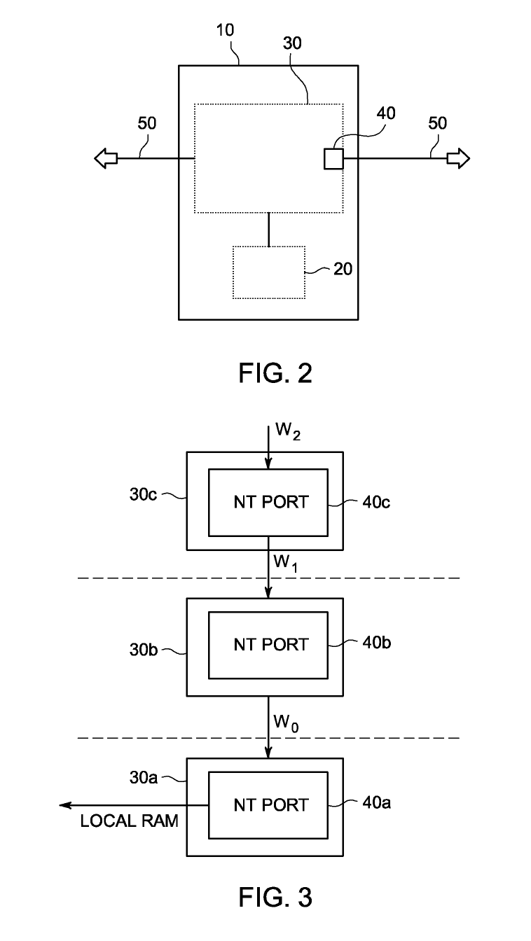

FIG. 2 is a block diagram of an exemplary compute device 10 according to the present invention. The device 10 includes at least one CPU 20 having a single or multi-core processor. The CPU 20 of the device is connected to an internal bridge 30. The bridge 30 can be a PCIe bridge that has at least one NT port 40. The left and right arrows represent the physical connections or external expansion bus 50 connecting the device 10 to the daisy-chain topology and linking the device 10 with other devices in the network (not shown). Two ports of each bridge 30 are used to connect a device 10 to the external expansion bus 50. A third port of the bridge 30 connects internally to the PCIe bus of the device 10 and allows access to this device's 10 shared memory. This third port is used to send and/or receive data from and/or to the device 10 to other devices on the expansion bus 50. Data can be sent and/or received across either of the two ports connected to the expansion bus 50.

In a preferred embodiment, the bridge 30 is a PCIe bridge, or switch, and the physical connection 50 is a PCIe cable or connector. In one embodiment, there are multiple NT ports on each bridge. While one NT port is the minimal number to allow a PCIe daisy-chain topology, additional NT ports may also be used. Additional NT ports may allow for flexibility in the physical connector used to connect devices. For example, by reconfiguring NT ports a user can switch the physical connector from a PCIe cable to a proprietary stackable connector. In one embodiment, one or more of the compute devices 10 supports both a cable connector and a stacking connector to directly plug into a group of stacked compute devices, such as the stacked devices 10e-10g shown in FIG. 1B. In another embodiment, one of two ports that are provided on the PCIe bridge 30 to connect the device 10 to the external expansion bus 50 is a proprietary connector for direct device-to-device links. In yet another embodiment, one of two ports that are provided on the PCIe bridge 30 to connect the device 10 to the daisy-chain is configured to connect to a PCIe cable connector for a link with cables.

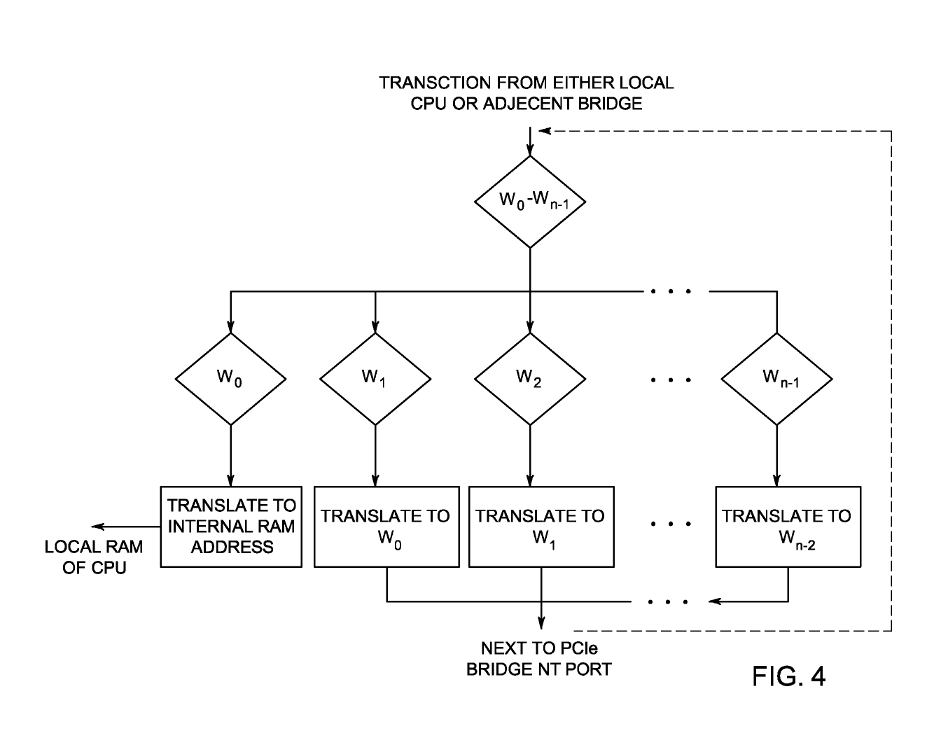

FIG. 3 is a block diagram illustrating an example of flow of data transfer from the initiating device, here, device 10c to a target device, here, device 10a. Devices 10a-10c are shown in FIG. 1A, however, only the bridge and ports of the respective devices are illustrated in FIG. 3. In this example, data flows from the NT port 40c present on the PCIe bridge 30c of the initiating device 10c, traverses the ring topology via the NT port 40b present on the PCIe bridge 30b of the intermediary device 10b, arrives at the NT port 40a on the PCIe bridge 30a, and terminates at the local RAM of the target device (not shown). Windows W₀, W₁, and W₂ represent the address window translations that occur as a transaction passes through each NT port. Each of NT ports 40c, 40b, and 40a shown in FIG. 3 implements the transaction flow illustrated in FIG. 4. FIG. 3 shows a transaction beginning with window W₂ and ending with window W₀ and a final translation to local RAM of a target device. This transaction is exemplary and applies to any transaction window Wₓ, which results in x number of NT port translations to reach W₀ and then a final translation to the local RAM of the target device.

FIG. 4 is a block diagram illustrating the address translation between devices connected in a daisy-chain topology according to the present invention. The NT port of each bridge accepts memory transactions for any of its configured memory windows (Wₙ₋₁ to W₀). Next, the specific window's address range is identified (e.g. W₁) and then the translation to another window occurs. The NT bridge translation is such that the window address range is decremented to the next lower windows range (i.e. Wₓ₋₁) and then passes the transaction with adjusted address window to the next bridge port. The exception is for transactions that enter the bridge for the W₀ address window which are mapped to the device's local internal memory. When one device wishes to send data to another device in the daisy-chain, the initiating CPU of selects a CPU of a target device. The initiating CPU then determines which port (left or right) that it needs to interface within in order to reach the target CPU. Assuming n devices on the daisy-chain, the initiating CPU then selects a memory Window [0 to n−1] and its corresponding memory address on the NT port for the desired target device. Finally, the initiating CPU begins a desired memory transaction, e.g. read or write data, to the CPU of the target CPU using the NT port memory address.

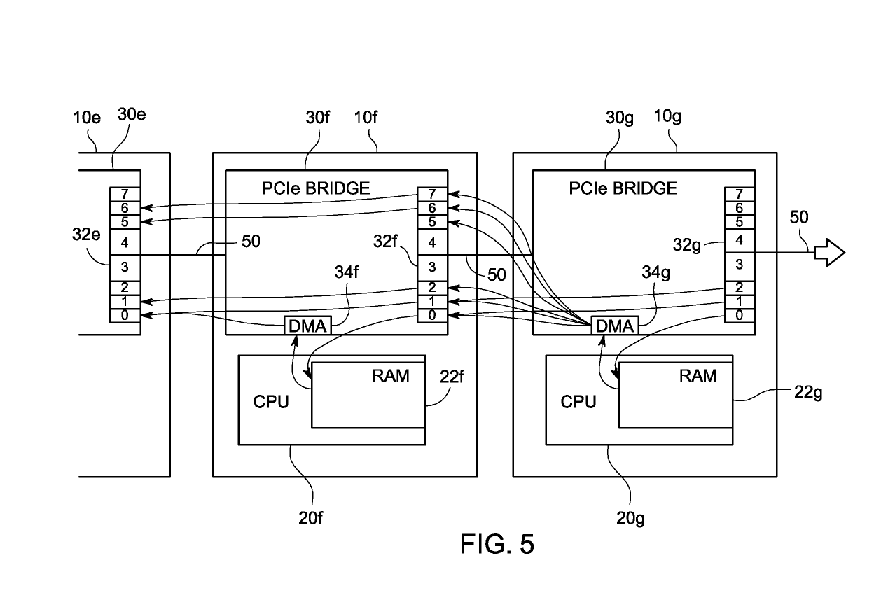

FIG. 5 is a diagram showing exemplary memory address translations between the respective PCIe bridges of three devices 10e-10g connected in the daisy-chain topology of the present invention. In one exemplary embodiment, an expansion bus 50 has eight devices connected in a daisy-chain topology, as illustrated in FIG. 1B. Each PCIe device 10a-10h on either end of the daisy-chain would need at least seven memory windows in its NT port setup in order to see shared memory space of each of the other seven devices, as illustrated in FIG. 5. Each window is a relative location to another device on the expansion bus 50. For example, device 10e has a PCIe bridge 30e having NT port 32e, device 10g has a PCIe bridge 30g having a NT port 32g, and similarly device 10f has a PCIe bridge 30f having an NT port 32f. Each of the devices 10e-10g has eight windows (Windows 0-7). Window 0 of device 10g is used to access the next adjacent device's memory, namely the RAM 22f of device 10f; Window 1 accesses device 10e, Windows 2 the device 10d (not shown), and so on.

To support this relative addressing, the bridge window's NT address translations must be setup to shift the data window down by 1 for each hop through the next PCIe bridge. For example, suppose a device needs to write a single byte of data to a device that is four nodes down the daisy-chain. The device should write the byte into Window 3 of its expansion bridge. This access to Window 3 on the bridge must be translated to forward the transaction to Window 2 of the next bridge in the chain. Similarly, Window 2 translates to Window 1, Window 1 to Window 0, and finally Window 0 maps to internal memory on the target device. Window translations must be setup in both directions on every PCIe bridge to allow bi-directional communication between PCIe device nodes. Thus, any PCIe device can share memory and that shared memory can be accessed by any other PCIe device on the expansion bus 50.

RAM 22g and RAM 22f present on each device is the respective device's internal memory. RAM is the final destination of all transactions accessing a particular compute device on the ring (read or write of RAM). Direct Memory Access (hereinafter DMA) components, DMA 34g and DMA 32f are hardware components that may optionally be used by one or more compute devices to initiate transactions to another compute device on the daisy-chain. DMA can be programmed to transfer a set of data to or from a target device which allows the local device's CPU to concurrently perform other operations while DMA is in progress. The use of DMA improves performance especially for large data transfers.

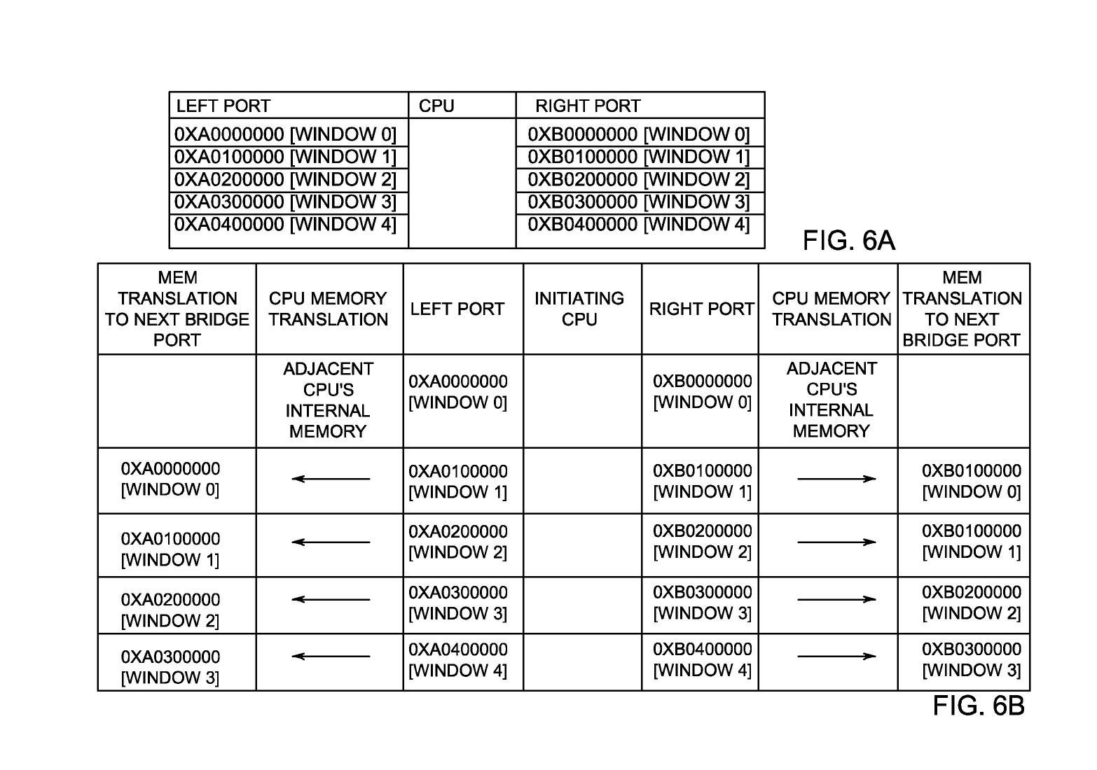

FIG. 6A is a table showing an example of memory windows on one embodiment of a PCIe bridge of a device according to the subject invention. In this example, a PCIe bridge on each device is configured such that there are two NT ports, one on the left having an address base of 0xA0000000, and one on the right having an address base of 0xB0000000. In this exemplary embodiment, assume there are at most five target devices to each side of any CPU of any given device in the daisy-chain. Thus, there are a total of ten memory windows that can be seen by each CPU of each device in the daisy-chain. In the case of a single NT bridge port in each device, one set of windows is the translation provided by the NT bridge port of the adjacent device, as seen through the transparent port of its own PCIe bridge.

While there is only one NT port required per PCIe bridge, any communication to an adjacent device in the system will go through the NT port of that device. In one direction, the CPU of a given compute device interfaces with the NT port windows of its own PCIe bridge. In the other direction, the CPU interfaces with the NT port windows of the adjacent device. Both the left and right ports in this embodiment are NT ports so an address translation can be made for each window. The Window 0 port address translation will be mapped to the internal CPU's memory of the “adjacent” CPU on the daisy-chain. The exact memory address can be different for each CPU. The other Windows (1-4) must have a memory translation to the next device's NT port and move the memory address down by 1 memory window (for example, 0xA0100000 translates to 0xA0000000 into the next NT port). Additional NT ports per device could be present. This includes an additional NT port on the other daisy-chain port or an NT port between the PCIe bridge and the local device's internal PCIe bus (port to local internal memory). Additional NT ports do not change the basic operation of the daisy-chain implementation described herein.

The address range of the memory windows determines which devices are accessed for any transaction (read or write of memory). The NT port address translations will direct any transaction to exactly one device in the daisy-chain. If a new device is added to the daisy-chain network and initialized, it will continuously listen for and process any transactions in its configured address range. FIG. 6B is a table showing an example of memory translations for one device's NT ports according to the subject invention. Because each device's CPU implements the same address translations, any device's CPU on the daisy-chain can exchange data with any other device's CPU. Here are two examples of how a given device's CPU is able to transfer data to reach a target device's CPU according to the present invention. Referring back to FIG. 1A, first consider the instance where an initiating device is device 10c and the target device is device 10d. The CPU of device 10c writes to 0xB0000000 which translates to internal memory of the CPU of device 10d. Second, consider the instance where the initiating device is device 10c and the target device is device 10e. In this case, the CPU of device 10c writes to 0xB0100000 which translates to 0xB0000000 within device 10d. Then, at the next NT port, 0xB0000000 translates to the internal memory of the CPU of device 10e.

Devices in the daisy-chain topology of the subject invention may have heterogeneous operating systems. For example, in FIG. 1A, device 10a may have a Microsoft Windows based operating system, whereas device 10b may have a Vxworks or similar operating system, and vice versa. Irrespective of the operating system, each of the compute devices are adapted and configured to share information with each of the other compute devices connected on the daisy-chain topology in a peer-to-peer arrangement.

The devices, systems and methods of the subject invention described herein allow for higher reliability of data transfer on a network. The extensible topology allows flexibility in connecting devices in a network with a high-speed interconnect through direct module-to-module connections or cabling. There can be a variable number of devices or nodes in the network, with easy addition or removal as necessary. Networked devices in the subject invention can be daisy-chained or ringed and are not limited to the conventional star topology or point-to-point connection of PCIe and similar standards. The network design does not need a fixed chassis or expansion bus root to allow processors to talk to each other. Additionally, the devices have a master/master relationship, and this multi-master mode allows all the devices to interact in a type of voting system. If a problem should arise, each device can come up with a solution and compare it with the solution of the other devices. This allows for more fail-safe and intelligent systems.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A system comprising:
a first set of devices, each of the first set of devices having a central processing unit connected to an internal PCIe bridge,
wherein each of the first set of devices are connected to each other in a peer-to-peer arrangement along an external PCIe bus in a daisy-chain topology.

2. The system of claim 1, wherein the PCIe bridge of each of the plurality of devices has at least one non-transparent port.

3. The system of claim 2, wherein the PCIe bridge of each of the plurality of devices has a first and second port for connecting its respective device to the external bus, and a third port for transmitting and receiving data to and from the respective device to one or more of the first set of devices in the daisy-chain topology.

4. The system of claim 1, further comprising:
a second set of devices, each of the second set of devices having a central processing unit connected to a PCIe bridge,
wherein the second set of devices are mechanically coupled together, and
wherein at least one of the second set of devices are connected along the external bus to the daisy-chain topology.

5. The system of claim 5, wherein the second set of devices communicate along a common communication channel when mechanically coupled.

6. A method of providing data transfer between an initiating device and a target device comprising the steps of:
providing a plurality of devices including an initiating device and a target device, each of the plurality of devices having a non-transparent Peripheral Component Interconnect Express (PCIe) bridge;
connecting the plurality of devices in a peer-to-peer daisy-chain topology; and
performing transfer of data by traversing the daisy-chain topology starting from the initiating device and ending at the target device.

7. The method of claim 6, wherein the PCIe bridge comprises at least a first port, a second port, and a third port.

8. The method of claim 7, wherein the step of connecting the plurality of devices in the daisy-chain topology includes cabling the first and second ports of each of the devices to an external expansion bus.

9. The method of claim 8, wherein the external expansion bus is a PCIe connector.

10. The method of claim 8, further comprising the step of:
connecting the third port to an internal PCIe bus within each of the plurality of devices, respectively.

11. The method of claim 8, further comprising the step of:
selecting one of the first port and the second port on the initiating device from which to begin transfer of the data based on a direction of the target device on the external expansion bus.

12. The method of claim 6, further comprising the step of:
reading or writing the data within an internal memory of the target device, after the daisy-chain topology has been traversed and transfer of data to/from the target device is completed.
